(19) United States
(12) Patent Application Publication
(10) Pub. No.: US 2014/0032256 A1
(43) Pub. Date: Jan. 30, 2014

(54) MULTI-PROJECT PORTFOLIO OPTIMIZATION

(71) Applicants: Howard M. HESS, Winnetka, IL (US); John A. RICKETTS, Clarendon Hills, IL (US)

(72) Inventors: Howard M. HESS, Winnetka, IL (US); John A. RICKETTS, Clarendon Hills, IL (US)

(73) Assignee: INTERNATIONAL BUSINESS MACHINES CORPORATION, Armonk, NY (US)

(21) Appl. No.: 13/560,604

(22) Filed: Jul. 27, 2012

(51) Int. Cl. G06Q 10/06

(52) U.S. Cl. 705/7.24

(57) ABSTRACT

A computer hardware-implemented method, system, and/or computer program product creates an optimized project portfolio. Parameters, which defined constraints on a project portfolio, are established. The project portfolio is populated with a mixture of critical path projects and critical chain projects. The project portfolio is then optimized by: in response to determining that start and finish dates have been committed to project sponsors of in-progress projects within the project portfolio, locking the in-progress projects into place on a portfolio timeline; adjusting expectations for the in-progress projects based on performance to date in order to extend a finish date; combining all other projects, which are not yet committed, in priority order onto the portfolio timeline by mapping each generic timeline onto actual calendar dates; and sliding unanchored projects forward or backward on the portfolio timeline to fill holes and smooth bulges in the portfolio timeline.

### BACKGROUND

The present disclosure relates to the field of computers, and specifically to the use of computers when managing project portfolios. Still more particularly, the present disclosure relates to the use of computers in optimizing a project portfolio.

A project portfolio is a collection of projects that are undertaken (or are planned to be undertaken) by an enterprise. The project portfolio itself is defined by the projects that have been accepted by the enterprise, such that the only optimization of the project portfolio is in the execution of the accepted projects. Thus, in the prior art the composition/creation of the project portfolio (i.e., selection of projects) is typically suboptimal.

### SUMMARY

A computer hardware-implemented method, system, and/or computer program product creates an optimized project portfolio. Parameters, which define constraints on a project portfolio, are established. The project portfolio is populated with a mixture of critical path projects and critical chain projects. The project portfolio is then optimized by: in response to determining that start and finish dates have been committed to project sponsors of in-progress projects within the project portfolio, locking the in-progress projects into place on a portfolio timeline; adjusting expectations for the in-progress projects based on performance to date in order to extend a finish date; combining all other projects, which are not yet committed, in priority order onto the portfolio timeline by mapping each generic timeline onto actual calendar dates; and sliding unanchored projects forward or backward on the portfolio timeline to fill holes and smooth bulges in the portfolio timeline.

### BRIEF DESCRIPTION OF THE SEVERAL VIEWS OF THE DRAWINGS

FIG. 1 depicts an exemplary system and network in which the present disclosure may be implemented;

FIG. 2 illustrates charts for critical path projects and critical chain projects;

FIG. 3 depicts Waterfall and Agile projects;

FIG. 4 illustrates template projects;

FIG. 5 depicts fixed and flexible capacity for projects;

FIG. 6 illustrates project-level constraints;

FIG. 7 depicts project portfolio optimization;

FIG. 8 illustrates components of a system for optimizing which projects will populate a project portfolio; and

FIG. 9 is a high-level flow chart of one or more steps performed by a computer processor for optimizing the creation of a project portfolio.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

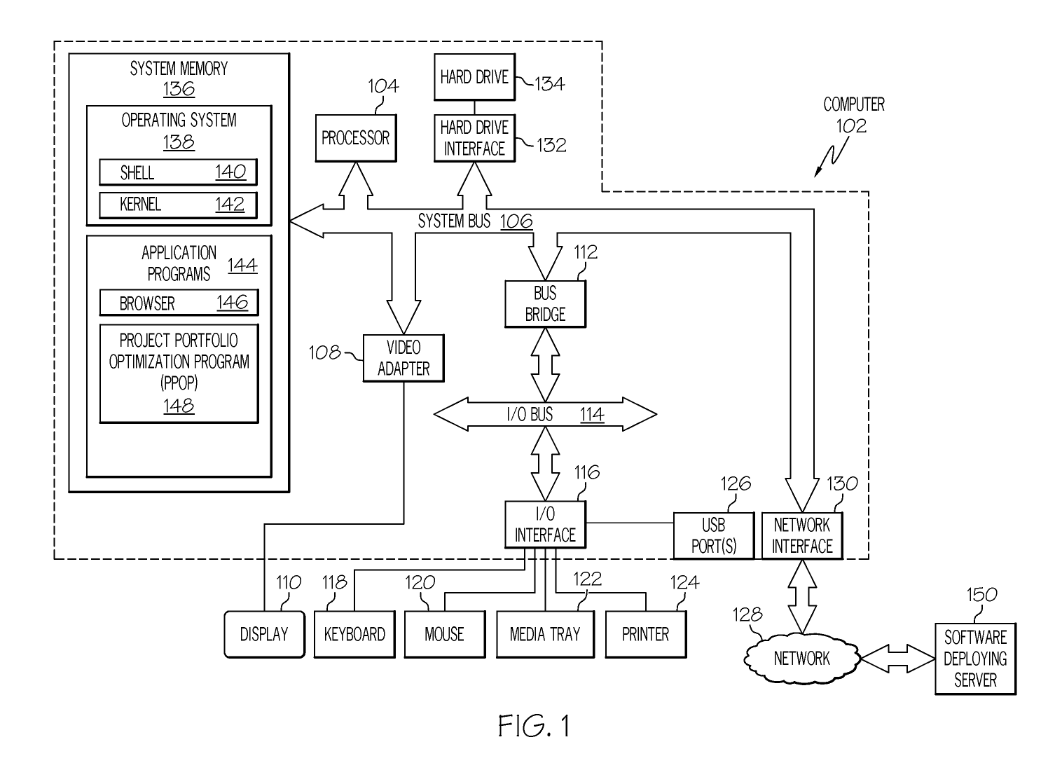

With reference now to the figures, and in particular to FIG. 1, there is depicted a block diagram of an exemplary system and network that may be utilized by and in the implementation of the present invention. Note that some or all of the exemplary architecture, including both depicted hardware and software, shown for and within computer 102 may be utilized by software deploying server 150.

Exemplary computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150, using a network interface 130. Network interface 130 is a hardware network interface, such as a network interface card (NIC), etc. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

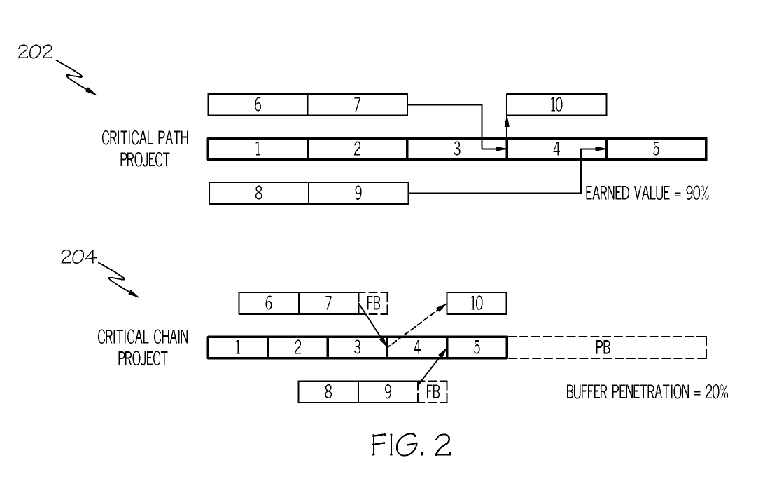

Application programs 144 in computer 102's system memory (as well as software deploying server 150's system memory) also include a project portfolio optimization program (PPOP) 148. PPOP 148 includes code for implementing the processes described below, including those described in FIG. 2. In one embodiment, computer 102 is able to download PPOP 148 from software deploying server 150, including in an on-demand basis, wherein the code in PPOP 148 is not downloaded until needed for execution. Note further that, in one embodiment of the present invention, software deploying server 150 performs all of the functions associated with the present invention (including execution of PPOP 148), thus freeing computer 102 from having to use its own internal computing resources to execute PPOP 148.

Note that the hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

As disclosed herein, the present invention presents a method, system, and/or computer program product for optimizing multiple projects to reflect changing priorities, scope, resources, timing, approach, or risk.

When priorities change, some projects should be completed earlier while others should be delayed or stopped. How well changing priorities can be accommodated across multiple projects can be a difficult question to answer when projects are in progress or competing for resources.

When scope increases, projects generally require more resources, more time, or a different approach. However, when scope decreases, it may not be possible to compress a project's schedule if the scope reduction is a reaction to unexpected resource constraints.

When resources change, projects may be accelerated or delayed, depending on how the change in resources affects productivity. Project resources include machines, materials, intellectual property, information technology, and people with particular skills.

When timing changes, it may or may not be still possible for the deliverables from one project to feed into another project without re-planning For example, when certain tasks, such as user testing, are tied to a quarterly business calendar, a one-week slip on one critical task can cause a three-month delay in the project due to resource availability.

When an approach to a project changes, this approach change can be due to a decision to transition to an implementation that is currently being more widely adopted (such as the Agile method). However, the approach is more often changed in order to accommodate reduced scope. One example of changing an approach to a project is to use open source code instead of writing new code.

When risk changes, either the probability of an event is altered or the consequences of an event are altered. For instance, if open source code cannot be used for legal reasons (i.e., a “risk changes”), then using open source code would increase the probability of adverse legal consequences (i.e., the “probability of an event is altered”). Thus, a project may have to be re-planned in order to develop equivalent functionality from scratch, thereby putting the completion date at risk (i.e., “consequences of the event are altered”).

For individual projects, the key to success is execution. That is, when progress departs from plan or when issues arise, getting the project back on track (e.g., back on schedule) most often leads to successful completion.

For a portfolio of projects, however, overall success often depends on planning and re-planning to optimize the selection, composition, and scheduling of projects. The present invention is a method and system for optimizing a project portfolio.

As the term is used in the present invention, “multiple projects” have dependencies on work products or deliverables (what is produced), approach (how it is produced), resources (who/what produces it), and schedules (when it is produced). Without such dependencies, any project could be readily re-planned without regard to other projects.

Despite such dependencies, however, multiple projects do tend to be re-planned separately rather than collectively because comprehensive re-planning is impractical. That is, when re-planned separately, the overall schedule across multiple projects may not be feasible, and this may not be discovered until it is too late to avoid late completion, budget overruns, cancelled projects, and sponsor dissatisfaction.

Multiple projects are hard to optimize due to demand exceeding capacity, competing priorities, incompatible constraints, inconsistent scope definitions, dependence on shared resources, linkage through shared milestones, ripple effects from changing approach, uncertainty, and the volume of calculations required.

In one embodiment, the present invention solves the multi-project optimization problem as follows:

Demand exceeding capacity is handled by constraining projects to available capacity or by acquiring the additional capacity necessary to accommodate selected projects.

Competing priorities are handled by a hierarchy of goals and tuning

Incompatible constraints are handled by relaxing one or more of the incompatible constraints until projects become feasible—or by marking some projects as infeasible so that constraints can be examined.

Inconsistent scope definitions are handled by highlighting missing deliverables (output from a project).

Dependence on shared resources is handled by resource leveling, resource replenishment, and reduction of multi-tasking.

Linkage through shared milestones is handled by minimizing if not eliminating most milestones and buffering the remainder.

Ripple effects from changing approach are handled by calculating the impact on related projects.

Uncertainty is handled by using standard project templates, adjusting for team performance history, and including appropriate buffers.

Volume of calculations is handled by automating the computations and recalculating only when necessary.

Thus, the present invention provides a method, system, and/or computer program product for optimizing a portfolio of multiple projects. Possible uses include portfolios in make-to-order manufacturing, maintenance and repair, building construction, ship building, software development, testing facilities, service centers, research labs, or professional practices. The common characteristic across these uses is that conflicts between projects may be better managed by periodically re-planning the portfolio rather than by managing projects in isolation until the conflicts trigger a crisis. One embodiment of the present invention is as follows:

First, draft plans for individual new projects are generated against a timeline with relative timing within the project rather than actual dates. For instance, if the first task is estimated at 10 time units, the plan will show it starting at time 1 and finishing at time 10. Those relative times in the draft plan will later be mapped to an actual calendar that reflects weekends, holidays, and shutdown periods so that conflicts between multiple projects can be observed and addressed.

Project plans can be unique, or they can be based on templates consisting of pre-defined tasks for producing specific deliverables with task estimates tied to a few high-level drivers. For instance, if the deliverable is computer software, the drivers could be number and complexity of use cases (i.e., how many steps are involved in a particular operation/project), number of test cases (i.e., how many variables are used), and number of concurrent users. Higher values on the drivers lead to higher task estimates.

Second, new project plans are incorporated into the existing portfolio based on goals and constraints. For example, if the goal is to schedule projects by priority, the portfolio is constrained to existing resources, and a new project has normal priority, that new project would be appended at the end of the overall portfolio plan. On the other hand, if the new project has high priority, it would be inserted into the portfolio plan with other high priority projects but before normal priority projects. This insertion could push normal priority projects with uncommitted completion dates later in the overall schedule. Conversely, cancellation of projects would cause others to be pulled earlier in the portfolio schedule to fill the gaps.

Third, highest priority is given to projects in progress, regardless of what their priority was at their launch, because their completion dates have already been committed. Furthermore, additional projects are not started unless sufficient capacity is available because this prevents excess work-in-progress from clogging the project pipeline and slowing other active projects. Tentative dates on projects can be issued any time, but date commitments are done as late as possible to preserve flexibility.

Fourth, conflicts are reconciled by several means which will be discussed later. For example, assume that a common conflict that needs to be reconciled is due to multiple projects competing for a finite resource, such as maintenance bays or lab equipment. This conflict can be reconciled by serializing projects on the tasks requiring that resource, by substituting another resource (for example, portable jacks and jigs instead of fixed maintenance bays), by redistributing the tasks, or by reengineering the product/service so that the resources are no longer required (by combining tasks or eliminating components).

Finally, conflicts that cannot be reconciled automatically are tuned, and then the portfolio is re-optimized based on changes to goals, priorities, and constraints. This tuning and re-optimization cycle may repeat.

The present invention is based on terminology and concepts that warrant explanation. They are explained in the following sections.

Critical Chain vs. Critical Path

Critical Path (CP) has been the most widely used project scheduling method for decades. Critical Chain (CC) is much less common, but growing. The plan for an individual project follows one method or the other, not both. Here is a summary of the differences:

CP uses task estimates with 80% or higher confidence because it assumes every task can be completed on time.

CC uses task estimates with 50% confidence because it assumes that some tasks will finish early enough to offset occasional late finishes on other tasks. Note that 80% estimates have a duration that is approximately twice as long as 50% estimates.

CP embeds contingency in task estimates because it assumes that if all tasks are completed on time then the project overall will be completed on time.

CC moves contingency into time buffers at the end of the project and wherever a series of non-critical tasks feeds a critical task because time buffers protect the entire project.

Even with time buffers, CC plans are about 25% shorter than equivalent CP plans.

Resource leveling is scheduling of tasks for each individual worker so that he or she is not overloaded and can work on one task at a time.

In CP, resource leveling is optional, but encouraged.

In CC, resource leveling is mandatory.

CP starts tasks as soon as possible (ASAP) to conserve task-level contingency. CC starts tasks as late as possible (ALAP) to avoid excess work in progress.

CP uses project milestones and resource utilization for its work rules. Those rules say workers must strive to complete every task on time and keep busy by switching among multiple tasks.

CC uses the relay-race work rule. It says workers must work as fast as possible on just one task at a time and not seek additional work simply to attain high utilization.

CP uses earned-value reporting to track progress in terms of percent complete. However, projects tracked this way are notorious for being stuck at 90% complete.

CC uses buffer penetration reporting to track progress in terms of buffer penetration, which is the amount of the time buffer consumed to date by late task completions. Projects tracked by buffer penetration are more likely to finish on time.

Portfolios typically are composed entirely of CC or CP plans because those methods are based on fundamentally different management philosophies. Thus, project portfolios tend to remain entirely on CP or migrate entirely to CC. However, wholesale migration may be impossible for large enterprises or enterprises with disparate product/service lines. The present invention therefore accommodates both types of project plans within the same portfolio.

With reference now to FIG. 2, chart 202 (for critical path projects) and chart 204 (for critical chain projects) illustrate equivalent CP and CC projects, each comprising Tasks 1, 2, 3, 4, 5, 6, 7, 8, 9, and 10. Each project is composed of the same ten tasks, with Tasks 4 and 10 performed by the same resource. The horizontal axis represents time, so tasks shown in a row are performed serially, while tasks aligned vertically are performed concurrently. Arrows connect predecessors to successors where a series of tasks would not otherwise be obvious against the timeline. Similarly, there is an implicit arrow between each of the abutting task blocks 1-10. Note that the arrow from Task 7 to Task 4 indicates that the completion of Task 7 and the completion of Task 3 are prerequisites to beginning Task 4. However, Task 7 ordinarily would be completed before Task 3 even begins. Thus, this additional time to complete Task 7 is known as “slack”.

The critical path (set of tasks with no slack time) and critical chain (set of tasks with no slack time and no resource conflicts) have bold outlines. Though the critical path and critical chain consist of the same tasks in this figure, they may include different tasks in actual project plans.

CC slides Task 10 later in the schedule to remove the resource conflict with Task 4. This example of CP does not remove that conflict, so multi-tasking between Task 4 and 10 could delay completion of Task 4, which is on the critical path.

CP starts tasks ASAP, while CC starts tasks ALAP. CP embeds contingency in every task, while CC moves contingency to feeding buffers (FB) and the project buffer (PB). Finally, CP tracks progress by earned value, while CC tracks it by buffer penetration.

Waterfall vs. Agile

The Waterfall method gets its name from project plans composed of a sequence of tasks with cascading work products. The Agile method gets its name from project plans composed of multiple task iterations with work products refined or extended during each iteration. For instance, on information technology projects using Agile, there are multiple iterations of analysis, design, code, and test tasks.

The Waterfall method assumes that requirements can be discovered early and they will not change. The Agile method assumes that requirements cannot be discovered early and they are changeable.

The Iron Triangle of project management is a principle that states that there is a tradeoff between scope, resources, and schedule. Alternatively, it is sometimes expressed as a tradeoff between speed, cost, and quality, as in “You can have it fast, cheap, or good; but you only to get to pick two.” In either form, the rule is that schedules are not indefinitely compressible by adding resources.

Waterfall takes scope and resources as relatively fixed constraints and generates a plan where the schedule is the unknown. In contrast, Agile takes schedule and resources as fixed constraints and generates a plan where scope is the unknown. In other words, Waterfall is supposed to deliver full scope even if it takes longer or costs more than planned, while Agile is supposed to deliver with fixed schedule and cost even if it delivers less than full scope.

Portfolios can be composed of both Waterfall and Agile projects. Waterfall is most often used on very large projects, though Agile can be used on projects of any size. However, the Iron Triangle applies to both methods: neither are immune to task-omission or over-optimism that lead to infeasible plans.

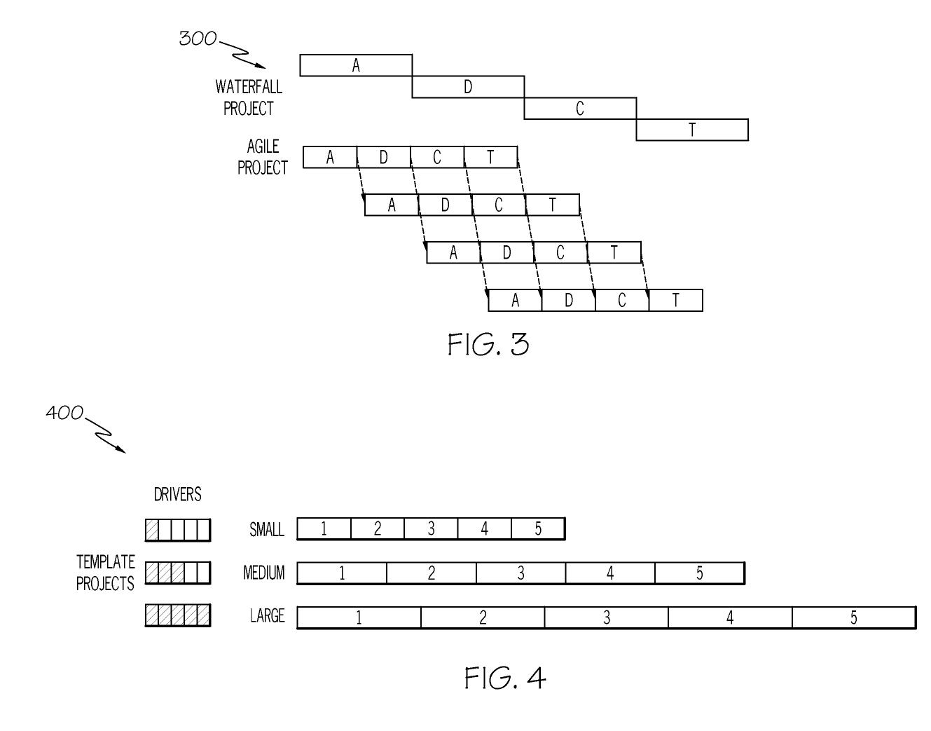

With reference now to FIG. 3, chart 300 illustrates Waterfall and Agile projects. The tasks are analysis (A), design (D), code (C), and test (T). Waterfall has a single sequence, while Agile has iterations. The iterations are illustrated as overlapping to imply that as a worker finishes with analysis on one iteration, he or she moves on to analysis in the next iteration rather than waiting for the entire iteration to be completed. Likewise, workers doing design, code, and test each perform their task on successive iterations. However, task specialization is not required by the Agile method, so iterations can be serial rather than overlapping.

Custom vs. Template

A custom plan has some distinguishing characteristics, and in the extreme, it may be one of a kind In contrast, a template plan is highly repeatable. For example, a spec house is built from a custom plan, while tract houses are built from a repeatable plan.

Templates are commonly used for projects that perform similar steps on similar objects for different customers or subsets of objects for the same customer. For example, rebuilding a particular type of complex machine within each customer's factory, can be done with a template plan. Similarly, renovating software spanning multiple systems for one customer, can be done with a template plan.

Portfolios can be composed of both custom and template projects. However, a custom plan has to be based on task estimates, while a template plan can be generated from a small set of drivers.

Template projects are illustrated in the graph 400 shown in FIG. 4. The key features are (1) all projects consist of the same tasks, but (2) estimates of work effort and task duration are generated from drivers.

Fixed vs. Flexible

Fixed capacity means projects are planned and performed without changing the number of workers or machines. Flexible capacity means workers or machines are increased or decreased according to demand. These are merely end points on a continuum of possibilities. But relatively fixed capacity is the norm, except in highly seasonal businesses.

A resource management method known as Replenishment adjusts capacity in direct response to actual demand. Though capacity can be adjusted within one firm, it is also possible for a firm to use business partners, subcontractors, other members of the supply chain, or even the customer's workers to create flexible capacity.

For purposes of managing a portfolio of projects, whether capacity is fixed or flexible has a substantial impact on how multiple projects are optimized. When demand exceeds supply, fixed capacity delays some projects. When supply exceeds demand, fixed capacity means some resources will be idle at times. With flexible capacity, however, the mismatch between demand and supply is smaller and may approach zero.

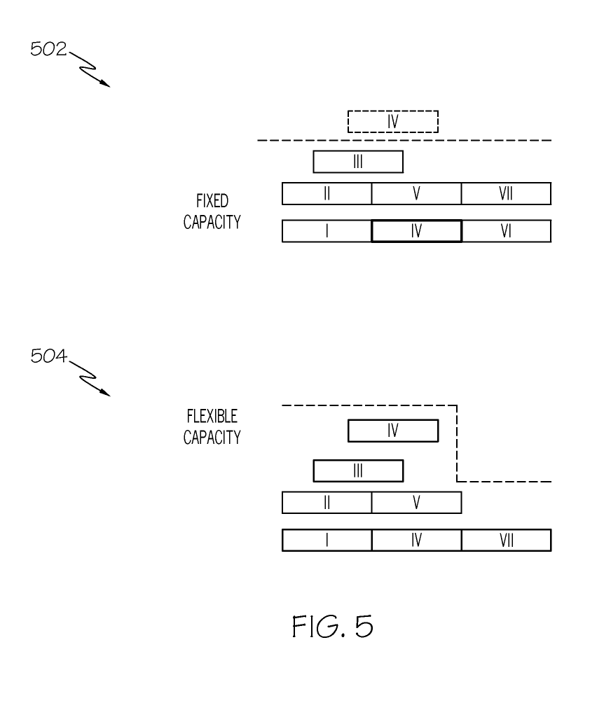

Fixed and flexible capacity are illustrated in chart 502 (fixed capacity) and chart 504 (flexible capacity) of FIG. 5. Projects are identified by Roman numerals, and their horizontal position indicates their place in the schedule. Exploding any of these projects would reveal their task structure, as illustrated previously. Capacity is indicated by the dashed line.

Assuming capacity is sufficient for only three projects at once, the fixed capacity scenario shows Project IV being delayed until capacity is available. In contrast, the flexible capacity scenario shows sufficient capacity for Project IV to be completed according to the project sponsor's request, but then capacity will be reduced once the bulge in the schedule is passed unless additional projects fill in the schedule.

Since the focus of the present invention is portfolio optimization, this illustration shows capacity management at the project level. In practice, however, capacity is adjusted by skill group or machine group because some groups typically have more slack capacity than others.

Pipelining, Joining, Anchoring, vs. Independence

Pipelining is a method of linking project schedules according to the availability of specific resources. For instance, if every aircraft needs some time in the hanger for maintenance and repair, pipelining allocates hanger time to each aircraft's project. Because hanger bays hold a finite number of aircraft at a time, schedules for the pipelined projects form a stair-step pattern on a Gantt chart as aircraft await their turn, get their turn, then proceed to other tasks. Additional time buffers are inserted between each project's turn to ensure preceding tasks are complete by the time the shared resource becomes available. One pipeline can contain projects from multiple templates or custom projects.

Joining is a method of linking project schedules according to dependencies on work products. Common patterns are finish-start or mid-project milestone. For instance, if Project A produces a work product needed by Project B, they share a milestone even if Project A and Project B each proceed to create their own deliverables. Once joined, changes to Project A also affect Project B.

Anchoring occurs when a project sponsor specifies a start date or finish date. As noted earlier, the Agile method lets scope float if both start and finish dates are specified. But the Waterfall method allows only the start date or the finish date to be specified because duration estimated from scope determines the other date. For purposes of later optimizing the portfolio by sliding projects around on the timeline, anchors can be “not later than”, “not earlier than”, or “this date”.

Independent projects are not linked because they have no direct dependencies. They are, however, subject to the Iron Triangle and general resource constraints. For instance, a six-month project probably cannot be launched today and completed three months from now. And if there is already a near-term bulge in the portfolio schedule, most resources are already busy, so the launch of that six-month project would have to be delayed.

All these methods strive to achieve project sponsors' target dates. However, optimization may change the sequence of projects and slide a set of pipelined or joined projects earlier or later on the portfolio timeline while working around anchored projects.

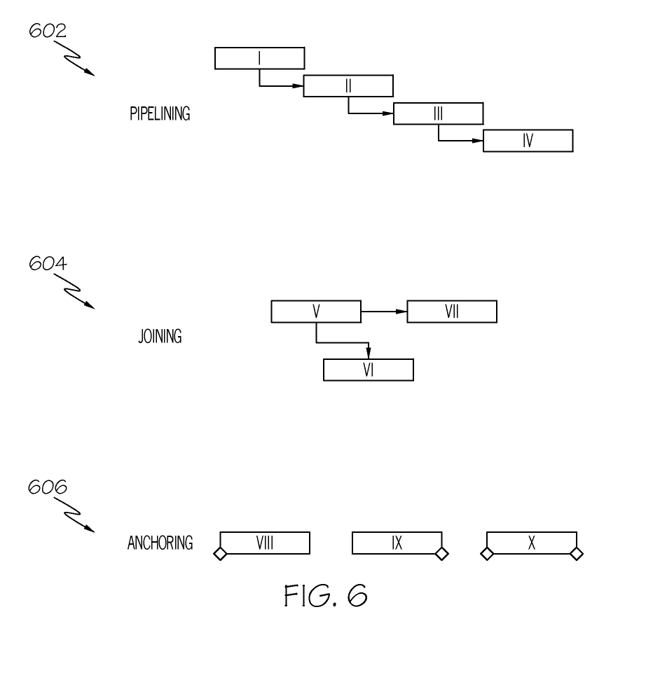

Project-level constraints are illustrated in charts 602, 604, and 606 in FIG. 6. Pipelining shows each project being scheduled only when the designated resource becomes available. The arrows include a time buffer between projects.

Joining shows Projects V and VI connected by mid-project milestones because Project V provides a work product to Project VI. It also shows Projects V and VII joined by a finish-start relation because Project V provides a deliverable to Project VII.

Finally, anchoring shows Project VIII having a designated start date, but a floating finish date. Conversely, Project IX has a floating start date, but a designated finish date. And Project X has designated dates for both start and finish, which means it also has to adopt the Agile method, which accommodates fixed durations.

### Project Portfolio Optimization

Project portfolio optimization occurs when the attainment of goals is as good as it can be, subject to various constraints. When there are multiple goals, it may not be possible to attain them all. Thus, the present invention uses a hierarchy of goals to resolve conflicts. It also uses minimally desirable values (soft targets) to avoid gross imbalances between goals.

For example, the goals (in descending order) might be project completion on time, within budget, full scope, no defects. If fixed capacity is a constraint, then contracts for some proposals might be rejected or renegotiated because the projects could not be completed on time. Similarly, if a particular project is already behind schedule (failing to meet the primary goal), it still might not be “crashed” (accelerated by the addition of more resources), because 1) this particular project is already significantly over budget (not meeting the minimally accepted value on the secondary goal); 2) crashing would likely lead to unacceptable defects; and/or 3) such crashing might still fail to get this particular project back on schedule.

Another example using the same goals and constraint might involve pipelined projects. If one customer cancels their project, that creates a hole in the schedule. Some other customers might gladly accept acceleration of their projects to fill that hole. But that is not necessarily true for all customers. Some might have internal dependencies that mean they want their project finished on a particular date, not early, because the deliverable is extremely perishable, fragile, or bulky. In that case, anchoring those customers' schedules could tell the optimization logic to leapfrog an unanchored project ahead to fill the schedule hole.

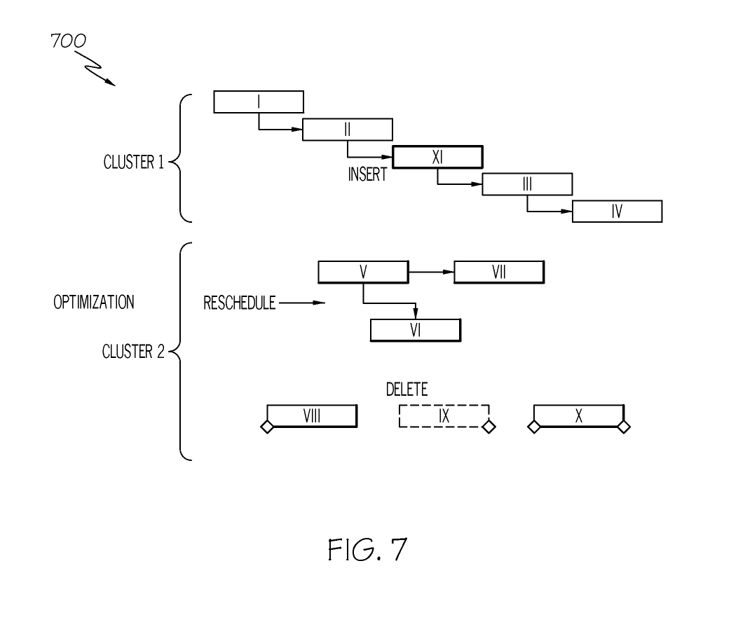

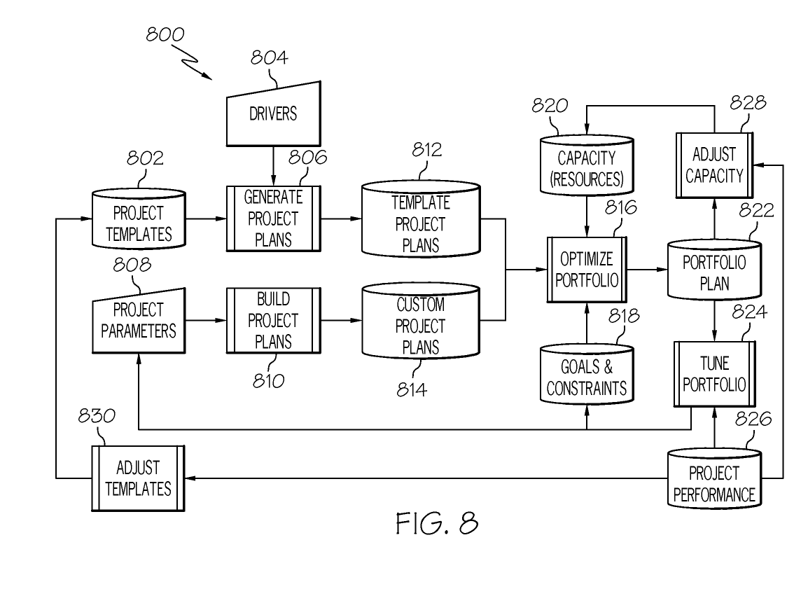

Portfolio optimization is illustrated in simplified form in FIG. 7. Not all possible optimizations are illustrated. Comparing FIG. 7 to FIG. 6 reveals that the pipelined projects are treated as a cluster separate from linked (i.e., “joining”), anchored (i.e., “anchoring”), and independent (not shown) projects. Thus, projects in each cluster can be rescheduled without regard to other clusters. This is a reasonable approach if the clusters do not compete for resources or if the resources can be allocated for optimization purposes.

In Cluster 1, a new project, Project XI, was inserted into the pipeline. This could occur if Project XI has higher priority or if the project sponsor requested a delay in Project III, thereby creating a hole in the pipeline schedule.

Assuming that Cluster 2 has capacity for only two concurrent projects, then concurrent execution of Projects V, VI, and VIII will create a bulge in the schedule. As depicted, Project IX in Cluster 2 was deleted from the schedule because it was cancelled or placed on hold. Rescheduling Project V to a later start eliminates the bulge and allows Projects V and VI to fill in some of the hole created by deletion of Project IX. Though not shown, further tuning might include insertion of a small project to fill the rest of the hole in the schedule.

Note that in one embodiment, each block (I, II, III, IV . . . XI) depicted in FIG. 6 and FIG. 7 represents a separate project that is made up of multiple tasks. Furthermore, in one embodiment, two or more of these projects are of a different type of project with regards to how they are managed. For example, Project I may be a critical path project, while Project II may be a critical chain project. Similarly, Project III may be a waterfall project while Project IV is an Agile project. Similarly, Project V may be a template project, while Project VI is a custom project. Similarly, Project VII may be a fixed capacity project, while Project VIII may be a flexible capacity project. Similarly, one project (e.g., Project I) may use pipelining, while another project (e.g., Project II) may use joining, while yet another project (e.g., Project III) may use anchoring as described above.

With reference now to FIG. 8, a chart 800 depicting components of a system for optimizing which projects will populate a project portfolio is presented. Project templates 802 and drivers 804 are used to generate template project plans 806. Project parameters 808 (tasks, precedence, estimates, priorities) are used to build custom project plans 810. Template (812) and custom (814) project plans are formed into an optimal portfolio 816 by using goals and constraints 818 (for example, “not before”) plus capacity (resource) data 820.

Although the optimal portfolio plan 822 is built automatically, tuning is an option. That tuning may result in adjustments to goals and constraints 818 or to customize project parameters, such as scope. Tuning 824 is supported by project performance data 826 (for example, which projects are late, on-time, or early).

Capacity adjustment 828 is also supported by the portfolio plan 822 plus project performance data 826. Project performance data 826 can also be used to adjust project templates 830.

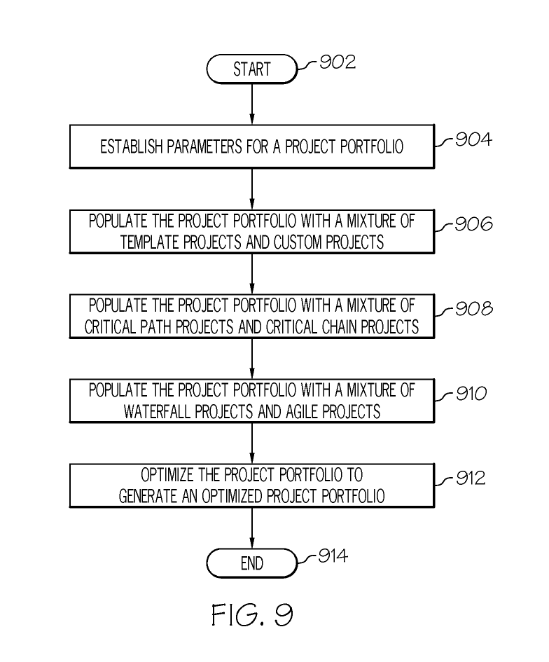

With reference now to FIG. 9, a high-level flow chart of one or more steps performed by a computer processor for optimizing a project portfolio during its creation is presented. Note that the method/process depicted applies to various entities, ranging from the entire portfolio to templates and individual projects.

After initiator block 902 (which may be initiated by a decision to create a project portfolio for an enterprise), parameters are established for a project portfolio according to one or more constraints identified by a computer processor (block 904). Such constraints include, but are not limited to the following:

A hierarchy of goals, such as on time, within budget, full scope, no defects, etc.

Minimum desirable values, especially for goals lower in hierarchy, which are less likely to be met outright.

A master calendar in terms of weekends, holidays, and shutdown periods. A decision is made by the processor, based on programmed constraint definitions, whether capacity for the portfolio will be fixed or flexible. If fixed, then the level is determined. If flexible, replenishment or other methods of resource management are implemented.

Whether projects will be clustered.

Which resources will be partitioned (to serve specific clusters) vs. allocated across clusters vs. shared without restriction.

Criteria for clustering projects, which could include common resources, similar deliverables, market segments, geographic location, project size, etc.

For each template used by candidate projects for the project portfolio, a determination is made as to whether that template will use a critical path or a critical chain topography. Similarly, a determination is made as to whether that template will use Waterfall or Agile. Similarly, a determination is made as to whether that template will generate a pipeline or independent project. The tasks, precedence, and resource assignments are then entered for that template. Formulas are created to convert driver values for that template into estimates of effort, cost, duration, and defects.

For each template project, drivers are input in order to generate draft project plans from the template. Resource leveling and buffer insertion are performed as required. A project plan is generated on a generic timeline with relative dates. If applicable, the template project is assigned to a cluster. Similarly, pipelines of template projects are formed if applicable.

For each custom project type, historical data or industry benchmarks are gathered to guide estimates of effort, cost, duration, and defects. Formulas are created to validate whether estimates are feasible (whether they satisfy the Iron Triangle of project constraints).

For each custom project, a decision is made whether to use a critical path (CP) or critical chain (CC) topography, as well as whether to use Waterfall or Agile. Tasks, precedence, estimates, and resource assignments are input into the algorithm that creates the project portfolio, using any available team performance history to adjust estimates. These estimates are then validated with Iron Triangle formulas for project type and revised until feasible. Resource leveling (i.e., reallocation) is then performed, if required. A custom project plan is then generated on (applied to) a generic timeline with relative dates, and if applicable, assigned to a cluster, added to a pipeline, and/or joined to other projects. Custom projects are then joined, if applicable. A project priority is entered with “not earlier than” or “not later than” parameters if applicable. Anchor projects are anchored, but without committing to dates far into the future (because this severely limits the ability to do portfolio optimization). The master calendar is then supplemented with project-level date constraints (non-working days).

With reference then to blocks 906, 908, and 910 in FIG. 9, the project portfolio is populated with a mixture of template projects and custom projects (block 906), critical path projects and critical chain projects (block 908), and waterfall projects and agile projects (block 910), where each of the projects are made up of multiple tasks. In one embodiment, one or more of these disparate types of projects share the use of at least one resource. For example, assume that the blocks in chart 602 in FIG. 6 are four tasks, labeled I-IV, which make up a single project (rather than I-IV representing different projects, as described above). The joining project shown in chart 604 in FIG. 6 has three tasks, labeled V-VII. In one embodiment, the resources used by Task I (e.g., personnel, equipment, software, materials, building facilities, etc.) may also be used by Task V.

Similarly, the Cluster 1 shown in FIG. 7 includes Tasks I-IV, which may use overlapping resources. Furthermore, Task XI, which is inserted between Tasks II and III, may also use resources that are used in the execution of Tasks II and/or III. As in the projects depicted in FIG. 6, Task I in FIG. 7 may also use the same resources used by Task V and/or Task X. However, in this case, Task V is trying to use resources that are currently being used by Task I. Thus, Tasks V, VI, and VII need to be rescheduled (shifted to the right—i.e., shifted to a later time) without causing Task V to overlap with Task X.

In the prior art, a project portfolio was either populated with template projects or custom projects, but never both; critical path projects or critical chain projects, but never both; or waterfall projects or agile projects, but never both. The reason for this homogeneity was that these different types of projects were deemed incompatible, due to their disparate architectures (described above). More specifically, certain rules applied to each type of project, so projects of different types were managed in separate portfolios. These rules controlled when a project should start/finish, which projects take precedence, etc. These rules are specifically tailored for the particular type of project. Thus, those rules are often incompatible in the sense that not all rules can be satisfied at once. For instance, critical chain projects often must use only currently available resources while critical path projects may be allowed to acquire additional resources as needed. However, the present invention overcomes this disparity by 1) allowing disparate types of projects to share resource usage; 2) allowing disparate types of projects to fluidly slide their start/end scheduled dates according to what other types of projects are being considered for inclusion in the project portfolio; 3) dynamically reallocating (inserting, deleting) tasks according to new priorities caused by the admission of a new project into the project portfolio; and 4) using a hierarchy of goals to resolve incompatible project rules.

The project portfolio is then optimized (block 912 in FIG. 9) by:
Locking projects into place on portfolio timeline if their dates have been committed to their project sponsors;
Adjusting expectations for projects in progress based on performance to date (earned value or buffer penetration), which could shorten but more often lengthens them;
Combining all projects not yet committed in priority order onto portfolio timeline by mapping each generic timeline onto actual calendar dates, skipping non-working days. For anchored projects, mapping can be forward from designated start date or backward from designated finish date;
Sliding unanchored projects forward or backward on timeline to fill holes and smooth bulges within the bounds defined by “not earlier than” or “not later than” parameters;
If capacity is flexible, indicating where adjustments must be made to accommodate projects;
If capacity is fixed, indicating where designated dates cannot be accommodated;
Indicating which projects are infeasible, if any; and/or
Tuning the schedule to fit projects into schedule holes by changing scope, if possible.

Periodically, portfolio optimization is redone/updated if the scope or approach or priority or linkage or risk of at least one project has changed, or resources (capacity) have changed. Note that projects that have not changed are not recalculated; rather, their generic timelines are simply re-mapped to the portfolio timeline.

The process ends at terminator block 914.

Thus, described herein is a portfolio optimization method and system that generates repeatable project plans from drivers and templates; allows template projects and custom projects in the same portfolio; allows Critical Path and Critical Chain projects in the same portfolio; allows Waterfall and Agile projects in the same portfolio; allows clustering of projects and partitioning of resources accordingly; allows projects to be pipelined, joined, anchored, or independent; allows fixed or flexible capacity management; and/or optimizes the portfolio according to a hierarchy of goals, plus soft targets on those goals.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A computer hardware-implemented method of creating an optimized project portfolio, the computer hardware-implemented method comprising:
a processor establishing parameters for a project portfolio, wherein the parameters define constraints on the project portfolio;
the processor populating the project portfolio with a mixture of critical path projects and critical chain projects;
the processor optimizing the project portfolio to create an optimized project portfolio by:
in response to determining that start and finish dates have been committed to project sponsors of in-progress projects within the project portfolio, locking the in-progress projects into place on a portfolio timeline;
adjusting expectations for the in-progress projects based on performance to date in order to extend a finish date;
combining all other projects, which are not yet committed, in priority order onto the portfolio timeline by mapping each generic timeline onto actual calendar dates; and
sliding unanchored projects forward or backward on the portfolio timeline to fill holes and smooth bulges within bounds defined by “not earlier than” or “not later than” parameters of the portfolio timeline.

2. The computer hardware-implemented method of claim 1, further comprising:
the processor populating the project portfolio with a mixture of template projects and custom projects.

3. The computer hardware-implemented method of claim 1, further comprising:
the processor populating the project portfolio with a mixture of waterfall projects and agile projects.

4. The computer hardware-implemented method of claim 1, further comprising:
the processor, in response to determining that capacity of resources used by at least one project in the project portfolio is flexible, determining where adjustments must be made to accommodate projects in the project portfolio.

5. The computer hardware-implemented method of claim 1, further comprising:
the processor, in response to determining that capacity of resources used by at least one project in the project portfolio is fixed, determining where designated start and finish dates cannot be accommodated.

6. The computer hardware-implemented method of claim 1, further comprising:
the processor determining which projects are infeasible for inclusion in the project portfolio, wherein an infeasible project is unable to share resources with other projects in the project portfolio.

7. The computer hardware-implemented method of claim 1, further comprising:
the processor tuning the portfolio timeline to fit projects into schedule holes by changing a scope of the projects.

8. A computer program product for creating an optimized project portfolio, the computer program product comprising:
a computer readable storage medium;
first program instructions to establish parameters for a project portfolio, wherein the parameters define constraints on the project portfolio;
second program instructions to populate the project portfolio with a mixture of critical path projects and critical chain projects;
third program instructions to optimize the project portfolio to create an optimized project portfolio by:
in response to determining that start and finish dates have been committed to project sponsors of in-progress projects within the project portfolio, locking the in-progress projects into place on a portfolio timeline;
adjusting expectations for the in-progress projects based on performance to date in order to extend a finish date;
combining all other projects, which are not yet committed, in priority order onto the portfolio timeline by mapping each generic timeline onto actual calendar dates; and
sliding unanchored projects forward or backward on the portfolio timeline to fill holes and smooth bulges within bounds defined by “not earlier than” or “not later than” parameters of the portfolio timeline; and wherein the first, second, and third program instructions are stored on the computer readable storage medium.

9. The computer program product of claim 8, further comprising:
fourth program instructions to populate the project portfolio with a mixture of template projects and custom projects; and wherein the fourth program instructions are stored on the computer readable storage medium.

10. The computer program product of claim 8, further comprising:
fourth program instructions to populate the project portfolio with a mixture of waterfall projects and agile projects; and wherein the fourth program instructions are stored on the computer readable storage medium.

11. The computer program product of claim 8, further comprising:
fourth program instructions to, in response to determining that capacity of resources used by at least one project in the project portfolio is flexible, determine where adjustments must be made to accommodate projects in the project portfolio; and wherein the fourth program instructions are stored on the computer readable storage medium.

12. The computer program product of claim 8, further comprising:
fourth program instructions to, in response to determining that capacity of resources used by at least one project in the project portfolio is fixed, determine where designated start and finish dates cannot be accommodated; and wherein the fourth program instructions are stored on the computer readable storage medium.

13. The computer program product of claim 8, further comprising:
fourth program instructions to determine which projects are infeasible for inclusion in the project portfolio, wherein an infeasible project is unable to share resources with other projects in the project portfolio; and wherein the fourth program instructions are stored on the computer readable storage medium.

14. The computer program product of claim 8, further comprising:
fourth program instructions to tune the portfolio timeline to fit projects into schedule holes by changing a scope of the projects; and wherein the fourth program instructions are stored on the computer readable storage medium.

15. A computer system comprising:
a central processing unit (CPU), a computer readable memory, and a computer readable storage medium;
first program instructions to establish parameters for a project portfolio, wherein the parameters define constraints on the project portfolio;
second program instructions to populate the project portfolio with a mixture of critical path projects and critical chain projects;
third program instructions to optimize the project portfolio to create an optimized project portfolio by:
in response to determining that start and finish dates have been committed to project sponsors of in-progress projects within the project portfolio, locking the in-progress projects into place on a portfolio timeline;
adjusting expectations for the in-progress projects based on performance to date in order to extend a finish date;
combining all other projects, which are not yet committed, in priority order onto the portfolio timeline by mapping each generic timeline onto actual calendar dates; and
sliding unanchored projects forward or backward on the portfolio timeline to fill holes and smooth bulges within bounds defined by “not earlier than” or “not later than” parameters of the portfolio timeline; and wherein the first, second, and third program instructions are stored on the computer readable storage medium for execution by the CPU via the computer readable memory.

16. The computer system of claim 15, further comprising:
fourth program instructions to populate the project portfolio with a mixture of template projects and custom projects; and wherein the fourth program instructions are stored on the computer readable storage medium for execution by the CPU via the computer readable memory.

17. The computer system of claim 15, further comprising:
fourth program instructions to populate the project portfolio with a mixture of waterfall projects and agile projects; and wherein the fourth program instructions are stored on the computer readable storage medium for execution by the CPU via the computer readable memory.

18. The computer system of claim 15, further comprising:
fourth program instructions to, in response to determining that capacity of resources used by at least one project in the project portfolio is flexible, determine where adjustments must be made to accommodate projects in the project portfolio; and wherein the fourth program instructions are stored on the computer readable storage medium for execution by the CPU via the computer readable memory.

19. The computer system of claim 15, further comprising:
fourth program instructions to, in response to determining that capacity of resources used by at least one project in the project portfolio is fixed, determine where designated start and finish dates cannot be accommodated; and wherein the fourth program instructions are stored on the computer readable storage medium for execution by the CPU via the computer readable memory.

20. The computer system of claim 15, further comprising:
fourth program instructions to determine which projects are infeasible for inclusion in the project portfolio, wherein an infeasible project is unable to share resources with other projects in the project portfolio; and wherein the fourth program instructions are stored on the computer readable storage medium for execution by the CPU via the computer readable memory.
